(19) United States
(12) Patent Application Publication
(10) Pub. No.: US 2025/0239524 A1
(43) Pub. Date: Jul. 24, 2025

(54) INTEGRATED CIRCUIT PROVIDING POWER GATING AND METHOD OF DESIGNING THE SAME

(71) Applicant: SAMSUNG ELECTRONICS CO., LTD., Suwon-si (KR)

(72) Inventors: Jianfeng Liu, Suwon-si (KR); Dongyoun Yi, Suwon-si (KR); Jun Seomun, Suwon-si (KR); Yeongyeong Shin, Suwon-si (KR); Byunghyun Lee, Suwon-si (KR); Eunju Hwang, Suwon-si (KR)

(73) Assignee: SAMSUNG ELECTRONICS CO., LTD., Suwon-si (KR)

(21) Appl. No.: 18/972,100

(22) Filed: Dec. 6, 2024

(30) Foreign Application Priority Data
Jan. 24, 2024 (KR) 10-2024-0010998

(51) Int. Cl. H01L 23/528; H01L 21/768; H01L 23/522; H10D 84/01; H10D 84/83; H10D 89/10

(52) U.S. Cl. CPC H01L 23/5286; H01L 21/76838; H01L 23/5226; H10D 84/0149; H10D 84/83; H10D 89/10

(57) ABSTRACT

An integrated circuit includes devices disposed on a substrate, a first backside pattern and a second backside pattern extending in parallel with the first backside pattern in a first direction, the first and the second backside patterns being disposed in a backside wiring layer below the substrate and configured to receive a first supply voltage provided to the devices, and a third backside pattern extending in the first direction between the first backside pattern and the second backside pattern and configured to receive a source supply voltage, wherein at least one of the devices is configured to provide or block the first supply voltage based on the source supply voltage.

### CROSS-REFERENCE TO RELATED APPLICATION

This application is based on and claims priority under 35 U.S.C. § 119 to Korean Patent Application No. 10-2024-0010998, filed on Jan. 24, 2024, in the Korean Intellectual Property Office, the disclosure of which is incorporated by reference herein in its entirety.

### BACKGROUND

Apparatuses and methods consistent with example embodiments relate to integrated circuits, and more specifically, to an integrated circuit providing power gating and a method of designing the integrated circuit.

In order to reduce power consumption of an integrated circuit, power gating may be used to cut off power supply to a block included in the integrated circuit while the block is not in use. Due to the demand for a high degree of integration and advancements in semiconductor processes, the widths, spaces, and/or heights of wirings in integrated circuits may decrease, and the influence of parasitic elements of wirings may increase. In addition, when high parasitic elements occur in power gating, a high IR drop may occur, and devices included in blocks may not operate normally due to the reduced supply voltage.

### SUMMARY

One or more example embodiments provide an integrated circuit providing power gating with reduced influence of parasitic elements and a method of designing the integrated circuit.

According to an aspect of the present disclosure, there is provided an integrated circuit including devices disposed on a substrate; a first backside pattern and a second backside pattern extending in a first direction in parallel with each other, the first and the second backside patterns being disposed in a backside wiring layer below the substrate and configured to receive a first supply voltage provided to the devices, and a third backside pattern extending in the first direction between the first backside pattern and the second backside pattern in the backside wiring layer and configured to receive a source supply voltage, wherein at least one of the devices is configured to provide or block the first supply voltage from the source supply voltage.

According to another aspect of the present disclosure, there is provided an integrated circuit including a plurality of cells including at least one power gating cell configured to provide or block a first supply voltage provided to the plurality of cells from a source supply voltage, a first backside pattern and a second backside pattern extending in a first direction in parallel with each other, the first and the second backside patterns being disposed in a backside wiring layer below a substrate and configured to receive the first supply voltage, and a third backside pattern extending in the first direction between the first backside pattern and the second backside pattern in the backside wiring layer and configured to receive the source supply voltage.

According to another aspect of the present disclosure, there is provided a method of manufacturing an integrated circuit including a plurality of cells including placing at least one power gating cell configured to provide or block a first supply voltage provided to the plurality of cells from a source supply voltage, placing a first backside pattern and a second backside pattern extending in a first direction in parallel with each other, the first and the second backside pattern being disposed in a backside wiring layer below a substrate and configured to receive the first supply voltage, and placing a third backside pattern extending in the first direction between the first backside pattern and the second backside pattern in the backside wiring layer and configured to receive the source supply voltage.

According to another aspect of the present disclosure, an integrated circuit may include: a plurality of target circuits; a plurality of power gating cells configured to receive a source supply voltage, and based on a power control signal, apply a supply voltage to an active target circuit and block an application of the supply voltage to an inactive target circuit, among the plurality of target circuits; a first backside wiring pattern extending along a longitudinal boundary of a first row, and configured to receive the supply voltage; a second backside wiring pattern extending along a longitudinal boundary of a second row, and configured to receive the supply voltage; and a third backside wiring pattern provided between the first backside wiring pattern and the second backside wiring pattern and configured to receive the source supply voltage.

### BRIEF DESCRIPTION OF THE DRAWINGS

Embodiments will be more clearly understood from the following detailed description taken in conjunction with the accompanying drawings in which:

FIGS. 1A and 1B are diagrams showing layouts of an integrated circuit according to some embodiments;

FIGS. 2A to 2D are diagrams showing examples of a device according to some embodiments;

FIG. 3 is a block diagram showing an integrated circuit according to one or more embodiments;

FIG. 4 is a diagram showing the layout of an integrated circuit according to one or more embodiments;

FIG. 5 is a diagram showing the layout of an integrated circuit according to one or more embodiments;

FIGS. 6A and 6B are diagrams showing layouts of an integrated circuit according to one or more embodiments;

FIG. 7 is a diagram showing a layout of an integrated circuit according to one or more embodiments;

FIGS. 8A to 8C are diagrams showing layouts of an integrated circuit according to some embodiments;

FIG. 9 is a diagram showing a layout of an integrated circuit according to one or more embodiments;

FIG. 10 is a diagram showing a layout of an integrated circuit according to one or more embodiments;

FIGS. 11A and 11B are diagrams showing layouts of an integrated circuit according to one or more embodiments;

FIG. 12 is a diagram showing a layout of an integrated circuit according to one or more embodiments;

FIG. 13 is a flowchart illustrating a method of manufacturing an integrated circuit, according to one or more embodiments;

FIG. 14 is a flowchart showing a method of designing an integrated circuit, according to one or more embodiments;

FIG. 15 is a flowchart showing a method of designing an integrated circuit, according to one or more embodiments;

FIG. 16 is a block diagram illustrating a system-on-chip (SoC) according to one or more embodiments; and

FIG. 17 is a block diagram illustrating a computing system including a memory storing a program, according to one or more embodiments.

### DETAILED DESCRIPTION OF THE EMBODIMENTS

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

While such terms as “first,” “second,” etc., may be used to describe various elements, such elements must not be limited to the above terms. The above terms may be used only to distinguish one element from another.

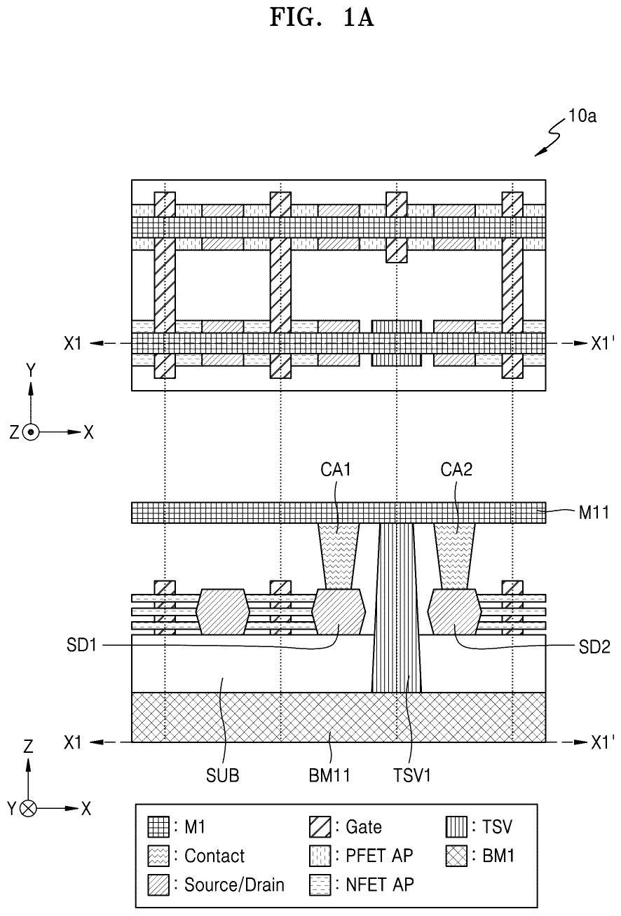

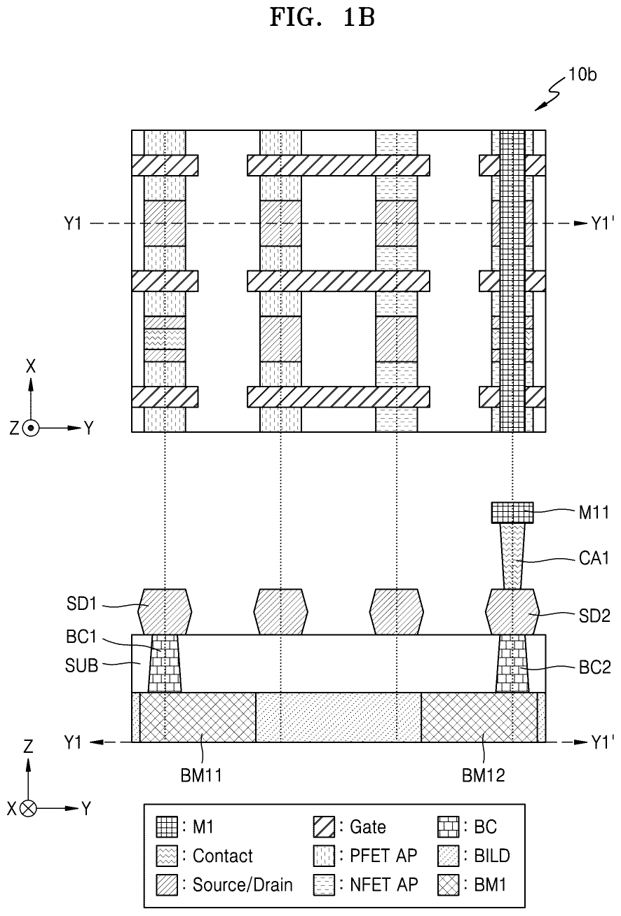

FIGS. 1A and 1B are diagrams showing layouts 10a and 10b of an integrated circuit according to some embodiments. FIG. 1A is a plan view of the layout 10a and a cross-sectional view of the layout 10a taken along an X1-X1′ line, and FIG. 1B is a plan view of the layout 10b and a cross-sectional view of the layout 10b taken along a Y1-Y1′ line.

Herein, the X-axis direction and the Y-axis direction may be referred to as a first direction and a second direction, respectively, and the Z-axis direction may be referred to as a vertical direction or a third direction. A plane including the X-axis and the Y-axis may be referred to as a horizontal plane, a component disposed in the +Z direction relative to the other component may be referred to as being above the other component, and a component disposed in the −Z direction relative to the other component may be referred to as being below the other component. In addition, the area of a component may refer to the size that the component occupies on a surface parallel to a horizontal plane, and the width of the component may refer to the length in a direction perpendicular to a direction in which the component extends. The surface exposed in the +Z direction may be referred to as a top surface, the surface exposed in the −Z direction may be referred to as a bottom surface, and the surface exposed in the +X direction or +Y direction may be referred to as a side surface. In the drawings, only some layers may be shown for convenience of illustration, and a via connecting a top pattern and a bottom pattern may be displayed for understanding even though the via is located below the top pattern. In addition, a pattern including a conductive material, such as a pattern of a wiring layer, may be referred to as a conductive pattern or may simply be referred to as a pattern.

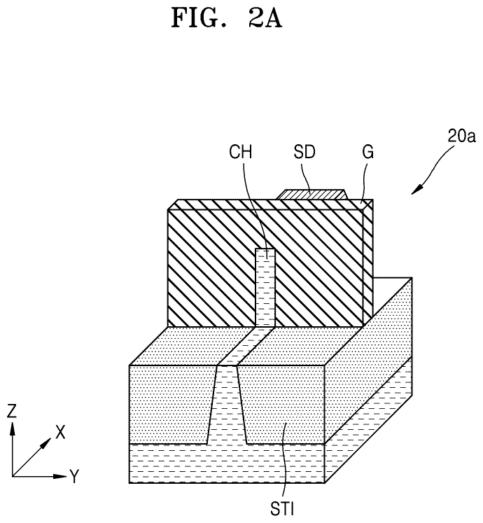

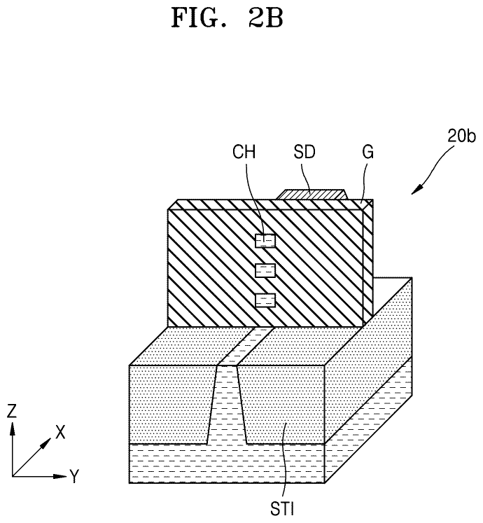

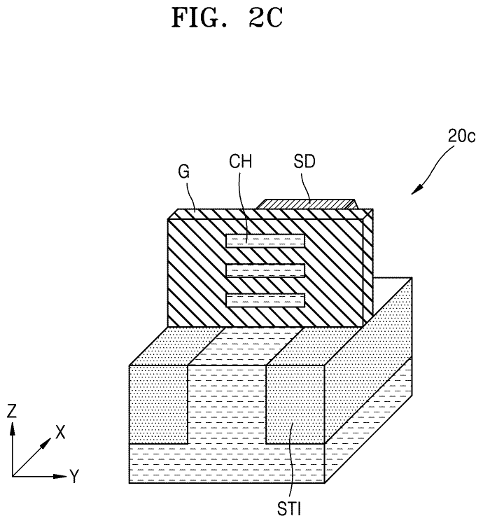

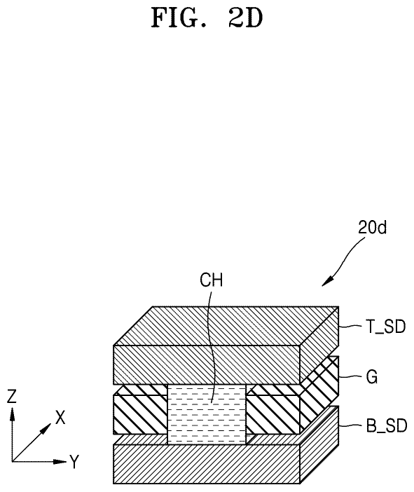

The integrated circuit may include semiconductor devices, such as transistors, placed on a substrate SUB. Examples of semiconductor devices placed on the substrate SUB may be described below with reference to FIGS. 2A to 2D. In addition, the integrated circuit may include wiring patterns extending above the elements, as well as wiring patterns extending below the substrate SUB. For example, as shown in FIG. 1A, the layout 10a may include wiring patterns (e.g., M11) extending in a front-side wiring layer M1 above the substrate SUB, as well as wiring patterns (e.g., BM11) extending in a backside wiring layer BM1 below the substrate SUB. In some embodiments, wiring patterns extending below the substrate SUB may be used to supply power to devices. As such, the backside patterns used to supply power to devices may be referred to as backside power rails. Available routing resources may be increased in the front-side wiring layers due to the patterns extending below the substrate SUB, and the integrated circuit may have a reduced area and/or an efficient structure. In particular, when the backside patterns are used for power supply, the devices may be provided with a supply voltage that does not drop due to reduced IR drop.

Referring to FIG. 1A, the layout 10a may include gates (or gate electrodes) extending in the Y-axis direction and active patterns APs extending in the X-axis direction. For example, as shown in FIG. 1A, p-channel field effect transistor (PFET) active patterns and n-channel field effect transistor (NFET) active patterns may extend in the X-axis direction and may intersect with gates extending in the Y-axis direction. Source/drains SD may be formed on both sides of a gate, and a channel may be formed between the source/drain SD. The first backside pattern BM11 may extend in the X-axis direction in the backside wiring layer BM1, and a backside interlayer dielectric (BILD) may be placed between the backside patterns in the backside wiring layer BM1. In some embodiments, the first backside pattern BM11 may provide a negative supply voltage to an NFET.

The layout 10a may include a through silicon via TSV penetrating the substrate SUB between the pattern of the backside wiring layer and the pattern of the front-side wiring layer. For example, as shown in FIG. 1A, a first through silicon via TSV1 may extend from the top surface of the first backside pattern BM11 to the bottom surface of the first front-side pattern M11. Accordingly, the first front-side pattern M11 and the first backside pattern BM11 may be (electrically) connected to each other through the first through silicon via TSV1.

The first front-side surface pattern M11 may be connected to a first source/drain SD1 through a first contact CA1. Accordingly, the first source/drain SD1 of the NFET may receive negative supply voltage from the first backside pattern BM11 through the first through silicon via TSV1, the first front-side pattern M11, and the first contact CA1. In addition, the first front-side pattern M11 may be connected to a second source/drain SD2 through a second contact CA2. Accordingly, the second source/drain SD2 of the NFET may receive negative supply voltage from a second backside pattern BM12 through the first through silicon via TSV1, the first front-side pattern M11, and the second contact CA2. In some embodiments, a via may be additionally placed between the first front-side pattern M11 and the first contact CA1 and/or between the first front-side pattern M11 and the first through silicon via TSV1.

Referring to FIG. 1B, the layout 10b may include gates extending in the Y-axis direction and active patterns extending in the X-axis direction. For example, as shown in FIG. 1B, PFET active patterns and NFET active patterns may extend in the X-axis direction and intersect with gates extending in the Y-axis direction. The source/drains SD may be formed on both sides of the gate, and a channel may be formed between the source/drains SD. The first backside pattern BM11 and the second backside pattern BM12 may extend in the X-axis direction in the backside wiring layer BM1, and a backside interlayer dielectric BILD may be placed between the first backside pattern BM11 and the second backside pattern BM12. In some embodiments, the first backside pattern BM11 may provide a positive supply voltage to the PFET, and the second backside pattern BM12 may provide a negative supply voltage to the NFET.

The layout 10b may include a backside contact BC penetrating the substrate SUB between the source/drain SD and the pattern of the backside wiring layer. For example, as shown in FIG. 1B, a first backside contact BC1 may extend from the top surface of the first backside pattern BM11 to the bottom surface of the first source/drain SD1. Accordingly, the first source/drain SD1 of the PFET may receive a positive supply voltage from the first backside pattern BM11 through the first backside contact BC1. In addition, a second backside contact BC2 may extend from the top surface of the second backside pattern BM12 to the bottom surface of the second source/drain SD2. Accordingly, the second source/drain SD2 of the NFET may receive a negative supply voltage from the second backside pattern BM12 through the second backside contact BC2. As shown in FIG. 1B, the first front-side pattern M11 may be connected to the second source/drain SD2 through the first contact CA1.

Power gating may refer to removing unnecessary power consumption by blocking power supply to a specific block included in an integrated circuit while the block is not in use. For example, while the block is in use or is in an active state, a supply voltage may be provided from a power source to devices included in the block. Conversely, while the block is not in use or is in an inactive state, the supply voltage from the power source may be blocked or cut off. As illustrated in the accompanying drawings, power gating may be implemented using a structure in which power is supplied through patterns of a backside wiring layer. Power gating according to embodiments of the present disclosure may reduce or minimize IR drop and allow the devices to consistently receive a stable supply voltage. Accordingly, power gating may enhance the reliability of the integrated circuit.

FIGS. 2A to 2D are diagrams showing examples of a device according to some embodiments. For example, FIG. 2A shows a Fin Field-Effect Transistor (FinFET) 20a, FIG. 2B shows a gate-all-around field effect transistor (GAAFET) 20b, FIG. 2C shows a multi-bridge channel field effect transistor (MBCFET) 20c, and FIG. 2D shows a vertical field effect transistor (VFET) 20d. For ease of illustration, FIGS. 2A to 2C show that one of two source/drain regions is removed, and FIG. 2D shows a cross-section of the VFET 20d taken through a plane parallel to a plane formed by the Y axis and Z axis and passing through a channel CH of the VFET 20d.

Referring to FIG. 2A, the FinFET 20a may include a fin-shaped active pattern extending in the X-axis direction and a gate G extending in the Y-axis direction between shallow trench isolations (STIs). The source/drain SD may be formed on both sides of the gate G, and accordingly, the source and the drain may be spaced apart from each other in the X-axis direction. An insulating film may be formed between a channel CH and the gate G. In some embodiments, the FinFET 20a may be formed by a plurality of active patterns spaced apart from each other in the X-axis direction and the gate G.

Referring to FIG. 2B, the GAAFET 20b may include active patterns, specifically, nanowires, which extend in the X-axis direction and are spaced apart from each other in the Z-axis direction. The GAAFET 20b may further include the gate G extending in the Y-axis direction. The source/drain SD may be formed on both sides of the gate G, and accordingly, the source and the drain may be spaced apart from each other in the X-axis direction. An insulating film may be formed between the channel CH and the gate G. It is noted that the number of nanowires included in GAAFET 20b is not limited to that shown in FIG. 2B.

Referring to FIG. 2C, the MBCFET 20c may include active patterns, specifically, nanosheets, which extend in the X-axis direction and are spaced apart from each other in the Z-axis direction. The MBCFET 20c may further include the gate G extending in the Y-axis direction. The source/drain SD may be formed on both sides of the gate G, and accordingly, the source and the drain may be spaced apart from each other in the X-axis direction. An insulating film may be formed between the channel CH and the gate G. It is noted that the number of nanosheets included in the MBCFET 20c is not limited to that shown in FIG. 2C.

Referring to FIG. 2D, the VFET 20d includes a top source/drain T_SD and a bottom source/drain B_SD spaced apart from each other in the Z-axis direction with the channel CH therebetween. The VFET 20d may include the gate G surrounding the circumference of the channel CH between the top source/drain T_SD and the bottom source/drain B_SD. An insulating film may be formed between the channel CH and the gate G.

Hereinafter, an integrated circuit including the FinFET 20a or the MBCFET 20c will be mainly described, but it is noted that the devices included in the integrated circuit are not limited to the examples of FIGS. 2A to 2D. For example, the integrated circuit may include a Fork Field-Effect Transistor (ForkFET) in which nanosheets for a P-type transistor and nanosheets for an N-type transistor are separated by dielectric walls so that the N-type transistor and the P-type transistor are closer together. In addition, the integrated circuit may include a bipolar junction transistor as well as a FET, such as a complementary field effect transistor (CFET), a negative capacitance field effect transistor (NCFET), a carbon nanotube (CNT) FET, etc.

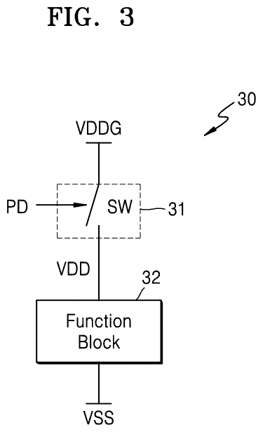

FIG. 3 is a block diagram showing an integrated circuit 30 according to one or more embodiments. Referring to FIG. 3, the integrated circuit 30 may include a power gating cell 31 and a function block 32. In some embodiments, power gating cell 31 may be considered part of the function block 32.

The integrated circuit 30 may include cells. A cell may be a standardized logic unit (e.g., logic gates (AND, OR, NOT), flip-flops, multiplexers, and other fundamental logic operations) of layout included in an integrated circuit and may be referred to as a standard cell. A cell may include a transistor and may be configured to perform a predefined function. In an integrated circuit, cells may be arranged in rows. For example, cells may be aligned and arranged in a plurality of rows extending in a first direction. A cell placed in one row may be referred to as a single height cell, and a cell placed in two or more consecutive rows may be referred to as a multi-height cell.

The function block 32 may operate based on a positive supply voltage VDD and a negative supply voltage VSS. For example, the function block 32 may include a plurality of cells, the plurality of cells may receive the positive supply voltage VDD and the negative supply voltage VSS, and may include devices operating based on power provided based on the positive supply voltage VDD and the negative supply voltage VSS.

The power gating cell 31 may be a circuit component used in the integrated circuit 30 to manage power consumption by selectively turning off the power supply to certain sections of the integrated circuit 30 when they are not in use. The power consumption management may be achieved through the use of switches (e.g., transistors) that control the connection between a power source and a target circuit block (e.g., the function block 32), by using a power control signal (e.g., a power down signal PD). Specifically, the power gating cell 31 may receive a power down signal PD and may include a switch SW that is turned on or off according to the power down signal PD. For example, the switch SW may be turned on in response to the deactivated power down signal PD and may provide the positive supply voltage VDD based on a source supply voltage VDDG to the function block 32. Accordingly, the function block 32 may operate in an active mode, and may be referred to as an active function block or an active target circuit block. In addition, the switch SW may be turned off in response to the activated power down signal PD and may block the positive supply voltage VDD based on the source supply voltage VDDG. Accordingly, the function block 32 may be set to a power saving mode, and power consumption may be eliminated by the function block 32. The function block 32 in the power saving mode may be referred to as an inactive function block or an inactive target circuit block. The source supply voltage VDDG may be received from outside the integrated circuit 30, or may be generated by the integrated circuit 30 from a voltage received from outside the integrated circuit 30.

In some embodiments, the switch SW may include at least one transistor. For example, the switch SW may include a PFET including a gate receiving the power down signal PD, a source receiving the source supply voltage VDDG, and a drain generating the positive supply voltage VDD. In some embodiments, in order to reduce the turn-on resistance of the switch SW, the switch SW may include a plurality of PFETs connected in parallel with each other. In some embodiments, the integrated circuit 30 may include a plurality of power gating cells. Hereinafter, as shown in FIG. 3, the power gating cell 31 providing the positive supply voltage VDD from the source supply voltage VDDG will be mainly described, but it is noted that some embodiments are not limited thereto. For example, the integrated circuit 30 may include a power gating cell that controls the negative supply voltage VSS and includes at least one NFET.

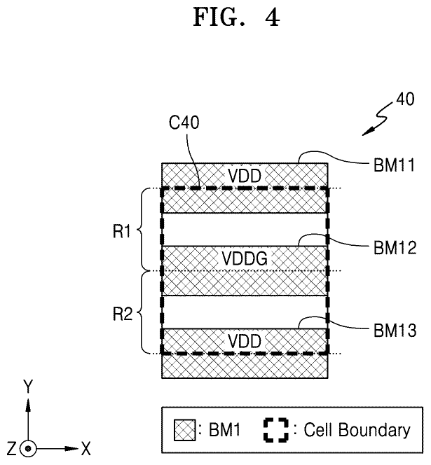

FIG. 4 is a diagram showing the layout 40 of an integrated circuit according to one or more embodiments. For example, FIG. 4 shows patterns of the backside wiring layer BM1 and a power gating cell C40. As described above with reference to FIGS. 1A and 1B, the patterns of the backside wiring layer BM1 may be used to provide a positive supply voltage and a negative supply voltage to devices.

Referring to FIG. 4, the layout 40 may include the first backside pattern BM11, a second backside pattern BM12, and a third backside pattern BM13 extending in the X-axis direction in the backside wiring layer BM1. As shown in FIG. 4, the first backside pattern BM11 may extend in the X-axis direction along a (longitudinal) boundary of a first row R1, the second backside pattern BM12 may extend in the X-axis direction along a (longitudinal) boundary between the first row R1 and a second row R2, and the third backside pattern BM13 may extend in the X-axis direction along a (longitudinal) boundary of the second row R2. The positive supply voltage VDD may be applied to the first backside pattern BM11 and the third backside pattern BM13, and the source supply voltage VDDG may be applied to the second backside pattern BM12 between the first backside pattern BM11 and the third backside pattern BM13.

The layout 40 may include a power gating cell C40. As described above with reference to FIG. 3, the power gating cell C40 may provide or block the positive supply voltage VDD based on the source supply voltage VDDG. The power gating cell C40 may be consecutively arranged in the first row R1 and the second row R2 extending in the X-axis direction, and may be a multi-height cell. The power gating cell C40 may receive the source supply voltage VDDG from the second backside pattern BM12 and provide the positive supply voltage VDD to the first backside pattern BM11 and the third backside pattern BM13 or block the positive supply voltage VDD. For example, the source supply voltage VDDG provided from outside the integrated circuit may be applied to the second backside pattern BM12, and the power gating cell C40 may receive the source supply voltage VDDG applied to the second backside pattern BM12. In addition, the first backside pattern BM11 and the third backside pattern BM13 may be electrically connected to cells included in the layout 40, and the cells may receive the positive supply voltage VDD from the power gating cell C40 through the first backside pattern BM11 and/or the third backside pattern BM13.

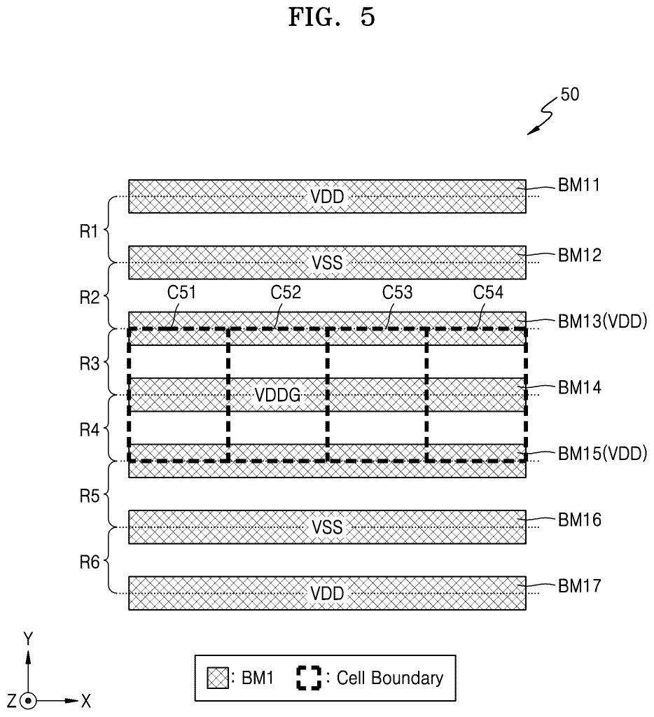

FIG. 5 is a diagram showing the layout 50 of an integrated circuit according to one or more embodiments. As shown in FIG. 5, the layout 50 may include the first backside pattern BM11, the second backside pattern BM12, the third backside pattern BM13, a fourth backside pattern BM14, a fifth backside pattern BM15, a sixth backside pattern BM16, and a seventh backside pattern BM17 of the backside wiring layer BM1, and a first power gating cell C51, a second power gating cell C52, a third power gating cell C53, and a fourth power gating cell C54. In some embodiments, each of the first power gating cell C51, the second power gating cell C52, the third power gating cell C53, and the fourth power gating cell C54 of FIG. 5 may correspond to the power gating cell C40 of FIG. 4.

The first backside pattern BM11, the second backside pattern BM12, the third backside pattern BM13, the fourth backside pattern BM14, the fifth backside pattern BM15, the sixth backside pattern BM16, and the seventh backside pattern BM17 may extend in parallel with each other in the X-axis direction in the backside wiring layer BM1. For example, as shown in FIG. 5, the first backside pattern BM11, the second backside pattern BM12, the third backside pattern BM13, the fourth backside pattern BM14, the fifth backside pattern BM15, the sixth backside pattern BM16, and the seventh backside pattern BM17 may extend in the X-axis direction along boundaries of the first row R1, the second row R2, a third row R3, a fourth row R4, a fifth row R5, and a sixth row R6. The positive supply voltage VDD may be applied to the first backside pattern BM11, the third backside pattern BM13, the fifth backside pattern BM15, and the seventh backside pattern BM17, the negative supply voltage VSS may be applied to the second backside pattern BM12 and the sixth backside pattern BM16, and the source supply voltage VDDG may be applied to the fourth backside pattern BM14. As shown in FIG. 5, backside patterns corresponding to the positive supply voltage VDD and backside patterns corresponding to the negative supply voltage VSS may be arranged alternately, while the fourth backside pattern BM14 may receive the source supply voltage VDDG instead of the negative supply voltage VSS below the first power gating cell C51, the second power gating cell C52, the third power gating cell C53, and the fourth power gating cell C54.

The first power gating cell C51, the second power gating cell C52, the third power gating cell C53, and the fourth power gating cell C54 may be consecutively arranged. For example, as shown in FIG. 5, the first power gating cell C51, the second power gating cell C52, the third power gating cell C53, and the fourth power gating cell C54 may be consecutively arranged in the third row R3 and the fourth row R4. As described above with reference to FIG. 4, each of the first power gating cell C51, the second power gating cell C52, the third power gating cell C53, and the fourth power gating cell C54 may provide, to the third backside pattern BM13 and the fifth backside pattern BM15, the positive supply voltage VDD from the source supply voltage VDDG received from the fourth backside pattern BM14 or block the positive supply voltage VDD. The first power gating cell C51, the second power gating cell C52, the third power gating cell C53, and the fourth power gating cell C54 may correspond to switches connected in parallel between the source supply voltage VDDG and the positive supply voltage VDD, and thus, the on resistance of power gating may be reduced.

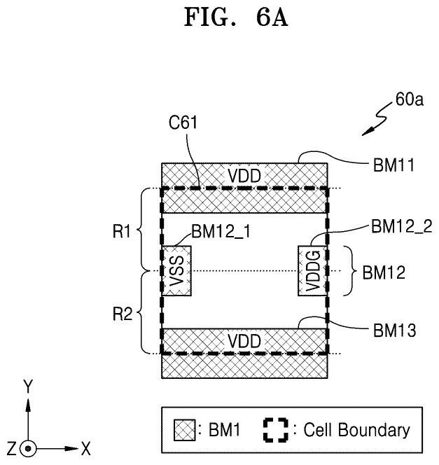

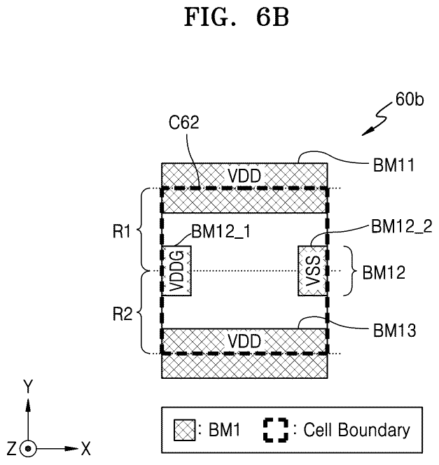

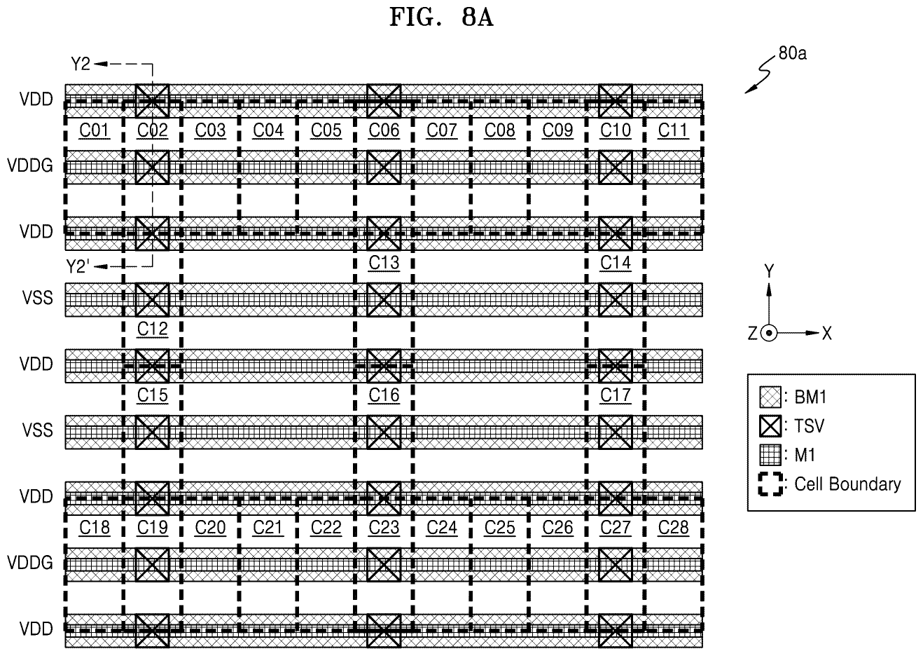

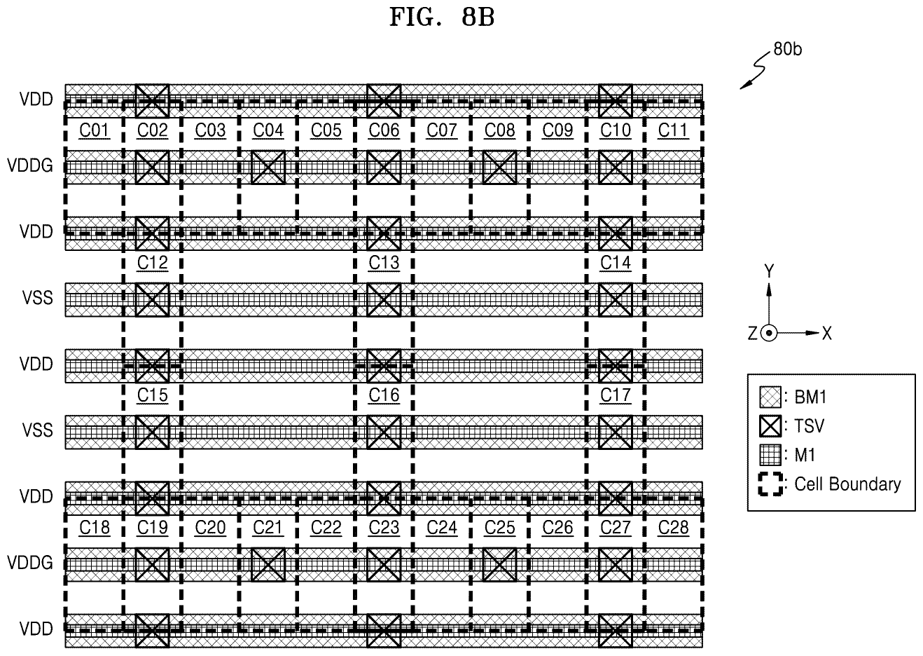

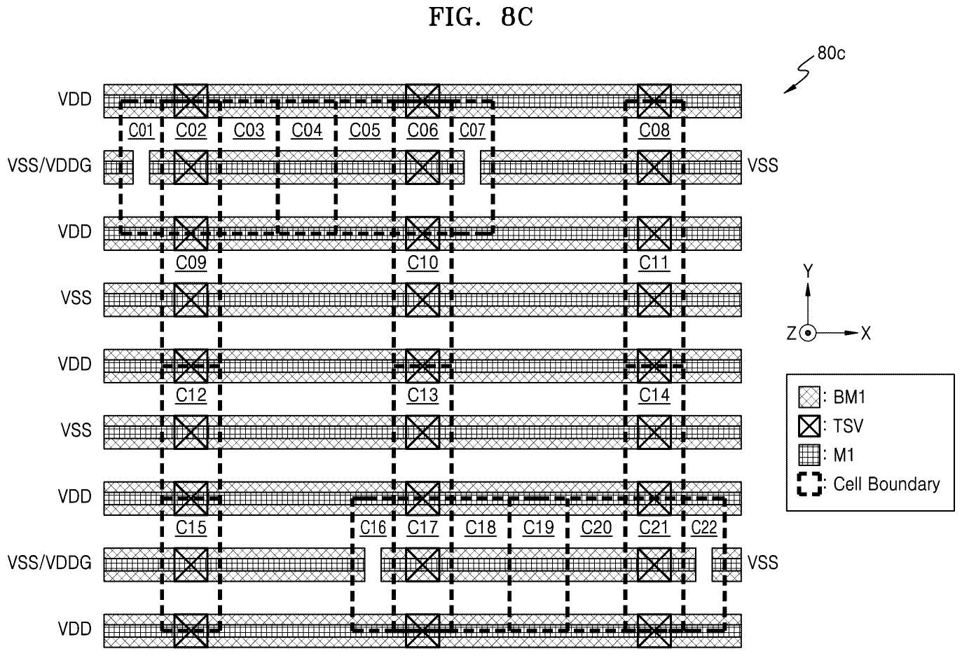

FIGS. 6A and 6B are diagrams showing layouts 60a and 60b of an integrated circuit according to one or more embodiments. For example, FIGS. 6A and 6B show a first end cell C61 and a second end cell C62 placed adjacent to a power gating cell. In some embodiments, an end cell may be placed adjacent to a power tap cell (PTC), as described below with reference to FIG. 8C. Descriptions of FIGS. 6A and 6B which are redundant with those above with reference to the drawings are omitted.

Referring to FIG. 6A, the layout 60a may include the first backside pattern BM11, the second backside pattern BM12, the third backside pattern BM13, and the first end cell C61. The first backside pattern BM11, the second backside pattern BM12, and the third backside pattern BM13 may extend in the X-axis direction, and the second backside pattern BM12 may include a first partial backside pattern BM12_1 and a second partial backside pattern BM12_2 which are spaced apart from each other in the X-axis direction. As shown in FIG. 6A, the positive supply voltage VDD may be applied to first backside pattern BM11 and the third backside pattern BM13, the negative supply voltage VSS may be applied to the first partial backside pattern BM12_1, and the source supply voltage VDDG may be applied to the second partial backside pattern BM12_2. Accordingly, a power gating cell may be placed on the right side of the first end cell C61 in the first row R1 and the second row R2, that is, adjacent to the second partial backside pattern BM12_2. In addition, a backside pattern to which the negative supply voltage VSS is applied may extend in the X-axis direction along the boundary of the first row R1 and the second row R2 adjacent to the left side of the first end cell C61, that is, the first partial backside pattern BM12_1.

Referring to FIG. 6B, the layout 60b may include the first backside pattern BM11, the second backside pattern BM12, the third backside pattern BM13, and the second end cell C62. The first backside pattern BM11, the second backside pattern BM12, the third backside pattern BM13 may extend in the X-axis direction, and the second backside pattern BM12 may include the first partial backside pattern BM12_1 and the second partial backside pattern BM12_2 which are spaced apart from each other in the X-axis direction. As shown in FIG. 6B, the positive supply voltage VDD may be applied to the first backside pattern BM11 and the third backside pattern BM13, the source supply voltage VDDG may be applied to the first partial backside pattern BM12_1, and the negative supply voltage VSS may be applied to the second partial backside pattern BM12_2. Accordingly, a power gating cell may be placed on the left side of the second end cell C62 in the first row R1 and the second row R2, that is, adjacent to the first partial backside pattern BM12_1. In addition, a backside pattern to which the negative supply voltage VSS is applied may extend in the X-axis direction along the boundary of the first row R1 and the second row R2 adjacent to the right side of the second end cell C62, that is, the second partial backside pattern BM12_2.

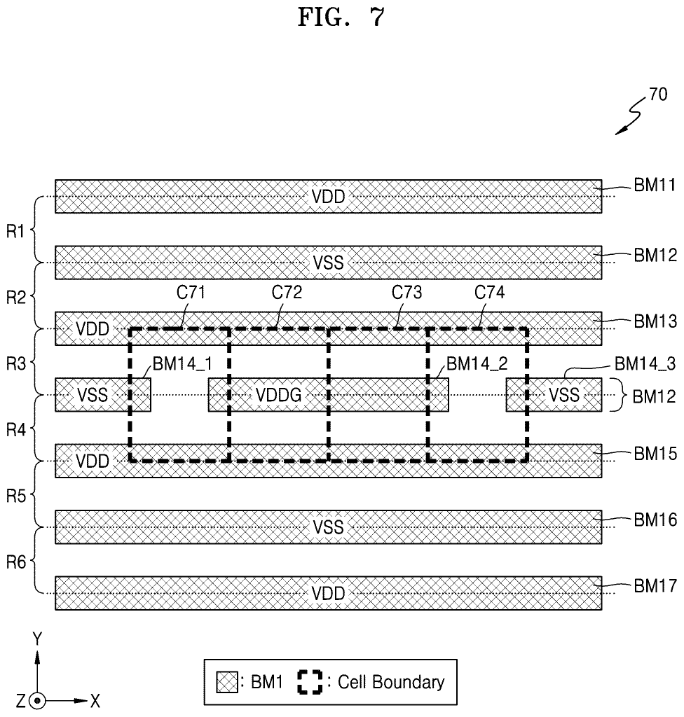

FIG. 7 is a diagram showing a layout 70 of an integrated circuit according to one or more embodiments. As shown in FIG. 7, the layout 70 may include the first backside pattern BM11, the second backside pattern BM12, the third backside pattern BM13, the fourth backside pattern BM14, the fifth backside pattern BM15, the sixth backside pattern BM16, and the seventh backside pattern BM17 in the backside wiring layer BM1, and a first cell C71, a second cell C72, a third cell C73, and a fourth cell C74. Descriptions of FIG. 7 which are redundant with those above with reference to the drawings are omitted.

The first backside pattern BM11, the second backside pattern BM12, the third backside pattern BM13, the fourth backside pattern BM14, the fifth backside pattern BM15, the sixth backside pattern BM16, and the seventh backside pattern BM17 may extend in parallel with each other in the X-axis direction in the backside wiring layer BM1. For example, as shown in FIG. 7, the first backside pattern BM11, the second backside pattern BM12, the third backside pattern BM13, the fourth backside pattern BM14, the fifth backside pattern BM15, the sixth backside pattern BM16, and the seventh backside pattern BM17 may extend in the X-axis direction along boundaries of the first row R1, the second row R2, the third row R3, the fourth row R4, the fifth row R5, and the sixth row R6. The positive supply voltage VDD may be applied to the first backside pattern BM11, the third backside pattern BM13, the fifth backside pattern BM15, and the seventh backside pattern BM17, and the negative supply voltage VSS may be applied to the second backside pattern BM12 and the sixth backside pattern BM16. The fourth backside pattern BM14 may include a first partial backside pattern BM14_1, a second partial backside pattern BM14_2, and a third partial backside pattern BM14_3 aligned in the X-axis direction. The negative supply voltage VSS may be applied to the first partial backside pattern BM14_1 and the third partial backside pattern BM14_3, and the source supply voltage VDDG may be applied to the second partial backside pattern BM14_2.

The first cell C71, the second cell C72, the third cell C73, and the fourth cell C74 may be consecutively arranged in the X-axis direction in the third row R3 and the fourth row R4. Each of the second cell C72 and the third cell C73 may be a power gating cell and, for example, may correspond to the power gating cell C40 of FIG. 4. The first cell C71 and the fourth cell C74 may be end cells and, for example, may correspond to the first end cell C61 of FIG. 6A and the second end cell C62 of FIG. 6B, respectively. As shown in FIG. 7, the second partial backside pattern BM14_2 to which the source supply voltage VDDG is applied may end below the first cell C71 and the fourth cell C74, respectively. In addition, the first partial backside pattern BM14_1 and the third partial backside pattern BM14_3 to which the negative supply voltage VSS is applied may end below the first cell C71 and the fourth cell C74, respectively. Accordingly, a backside pattern to which the negative supply voltage VSS is applied may be replaced with a backside pattern to which the source supply voltage VDDG is applied in a region where the power gating cell is placed. In some embodiments, different from what is shown in FIG. 7, end cells may be placed on both sides of one power gating cell, or end cells may be placed on both sides of more than two consecutively placed power gating cells.

FIGS. 8A to 8C are diagrams showing layouts 80a, 80b, and 80c of an integrated circuit according to some embodiments. For example, FIGS. 8A to 8C show the layouts 80a, 80b, and 80c each including a structure in which a backside pattern and a front-side pattern are connected to each other through the through silicon via TSV penetrating a substrate, as described above with reference to FIG. 1A. Hereinafter, redundant descriptions between FIGS. 8A to 8C will be omitted.

Referring to FIG. 8A, backside patterns may extend in parallel with each other in the X-axis direction in a backside wiring layer. The positive supply voltage VDD, the negative supply voltage VSS, or the source supply voltage VDDG may be applied to the backside pattern, and power gating cells may be placed on a backside pattern to which the source supply voltage VDDG is applied. For example, as shown in FIG. 8A, cells C01, C03, C04, C05, C07, C08, C09, C11, C18, C20, C21, C22, C24, C25, C26, and C28 placed on the backside pattern to which the source supply voltage VDDG is applied may correspond to the power gating cells.

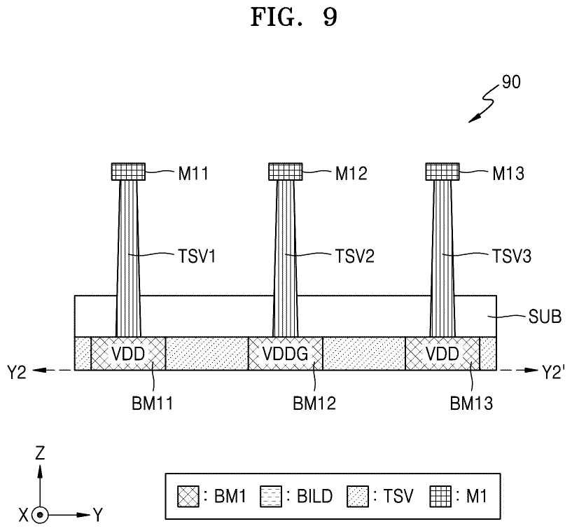

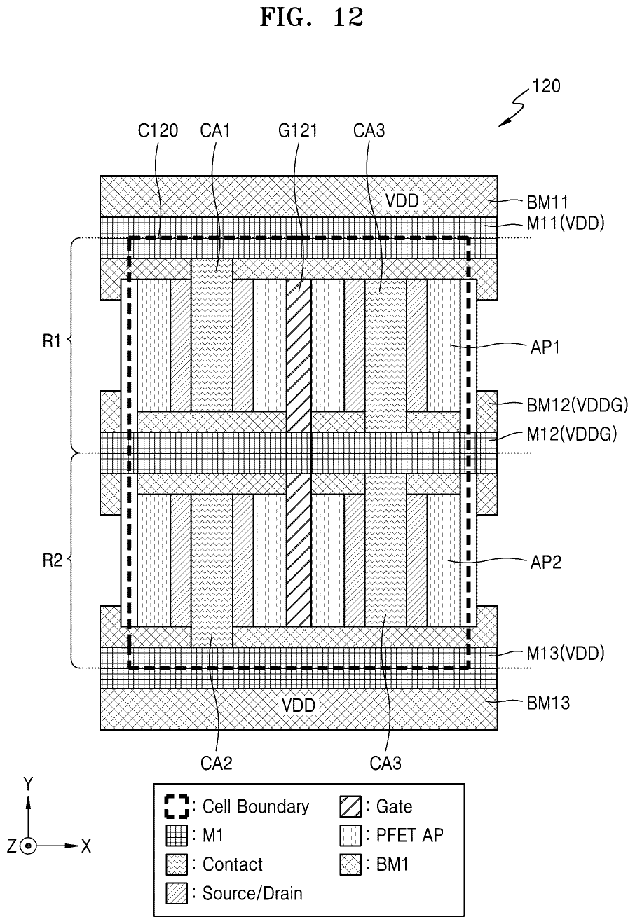

Front-side patterns may extend in parallel with each other in the X-axis direction in a front-side wiring layer. For example, as shown in FIG. 8A, the front-side patterns may extend in the X-axis direction along the backside patterns, for example, along boundaries of rows. The front-side pattern may equally receive the positive supply voltage VDD, the negative supply voltage VSS, or the source supply voltage VDDG applied to the backside pattern placed below. To this end, the layout 80a may include a cell, that is, the power tap cell PTC, including the through silicon via TSV extending in the Z-axis direction between the backside pattern and the front-side pattern. For example, as shown in FIG. 8A, cells C02, C06, C10, C12, C13, C14, C15, C16, C17, C19, C23, and C27 may respectively include the through silicon vias TSV, and be arranged and aligned in the Y-axis direction. A cross-section of the cell C02 that is the power tap cell PTC taken along a line Y2-Y2′ may be described below with reference to FIG. 9. The power gating cell may provide the positive supply voltage VDD to the front-side pattern from the source supply voltage VDDG that is applied to the front-side pattern or block the positive supply voltage VDD, as will be described below with reference to FIG. 12.

Referring to FIG. 8B, backside patterns may extend in parallel with each other in the X-axis direction in a backside wiring layer. The positive supply voltage VDD, the negative supply voltage VSS, or the source supply voltage VDDG may be applied to the backside pattern, and power gating cells may be placed on a backside pattern to which the source supply voltage VDDG is applied. For example, as shown in FIG. 8B, the cells C01, C03, C05, C07, C09, C11, C18, C20, C22, C24, C26, and C28 placed on the backside pattern to which the source supply voltage VDDG is applied may correspond to the power gating cells.

Front-side patterns may extend in parallel with each other in the X-axis direction in a front-side wiring layer. For example, as shown in FIG. 8B, the front-side patterns may extend in the X-axis direction along the backside patterns, for example, along boundaries of rows. The front-side pattern may equally receive the positive supply voltage VDD, the negative supply voltage VSS, or the source supply voltage VDDG applied to the backside pattern placed below. To this end, the layout 80b may include a cell, that is, the power tap cell PTC, including the through silicon via TSV extending in the Z-axis direction between the backside pattern and the front-side pattern. For example, as shown in FIG. 8B, the cells C02, C04, C06, C08, C10, C12, C13, C14, C15, C16, C17, C19, C21, C23, C25, and C27 may respectively include the through silicon vias TSV. Compared to the layout 80a of FIG. 8A, the layout 80b of FIG. 8B may further include power tap cells PTC C04, C08, C21, and C25 including only one through silicon via TSV. The power gating cell may provide the positive supply voltage VDD to the front-side pattern from the source supply voltage VDDG that is applied to the front-side pattern or block the positive supply voltage VDD, as will be described below with reference to FIG. 12.

Referring to FIG. 8C, backside patterns may extend in parallel with each other in the X-axis direction in a backside wiring layer. The positive supply voltage VDD, the negative supply voltage VSS, or the source supply voltage VDDG may be applied to the backside pattern, and power gating cells may be placed on a backside pattern to which the source supply voltage VDDG is applied. For example, as shown in FIG. 8C, the cells C03, C04, C05, C18, C19, and C20 placed on the backside pattern to which the source supply voltage VDDG is applied may correspond to the power gating cells.

Front-side patterns may extend in parallel with each other in the X-axis direction in a front-side wiring layer. For example, as shown in FIG. 8C, the front-side patterns may extend in the X-axis direction along the backside patterns, for example, along boundaries of rows. The front-side pattern may equally receive the positive supply voltage VDD, the negative supply voltage VSS, or the source supply voltage VDDG applied to the backside pattern placed below. To this end, the layout 80c may include a cell, that is, the power tap cell PTC, including the through silicon via TSV extending in the Z-axis direction between the backside pattern and the front-side pattern. For example, as shown in FIG. 8C, the cells C02, C06, C08, C09, C10, C11, C12, C13, C14, C15, C17, and C21 may respectively include the through silicon vias TSV, and aligned and placed in the Y-axis direction. The power gating cell may provide the positive supply voltage VDD to the front-side pattern from the source supply voltage VDDG that is applied to the front-side pattern or block the positive supply voltage VDD, as will be described below with reference to FIG. 12. The layout 80c may include end cells. For example, the cells C01 and C16 may correspond to the first end cell C61 in FIG. 6A, and the cells C07 and C22 may correspond to the second end cell C62 in FIG. 6B.

FIG. 9 is a diagram showing a layout 90 of an integrated circuit according to one or more embodiments. For example, FIG. 9 shows a cross-section of the layout 80a of FIG. 8A taken along the line Y2-Y2′. FIG. 9 will be explained with reference to FIG. 8A below.

Referring to FIG. 9, the first backside pattern BM11, the second backside pattern BM12, and the third backside pattern BM13 may extend in the X-axis direction in the backside wiring layer BM1. A first front-side pattern M11, a second front-side pattern M12, and a third front-side pattern M13 may extend in the X-axis direction in the front-side wiring layer M1. The source supply voltage VDDG may be applied to the second backside pattern BM12, and a second through silicon via TSV2 may penetrate the substrate SUB from a top surface of the second backside pattern BM12 and extend to a bottom surface of the second front-side pattern M12. Accordingly, as will be described below with reference to FIG. 12, the power gating cell (e.g., C03 in FIG. 8A) may receive the source supply voltage VDDG through the second front-side pattern M12 and output the positive supply voltage VDD to the first front-side pattern M11 and the third front-side pattern M13. The first through silicon via TSV1 may pass through the substrate SUB from a top surface of the first backside pattern BM11 and extend to a bottom surface of the first front-side pattern M11, and accordingly, the positive supply voltage VDD may be applied to the first backside pattern BM11. In addition, a third through silicon via TSV3 may pass through the substrate SUB from a top surface of the third backside pattern BM13 and extend to a bottom surface of the third front-side pattern M13, and accordingly, the positive supply voltage VDD may be applied to the third backside pattern BM13.

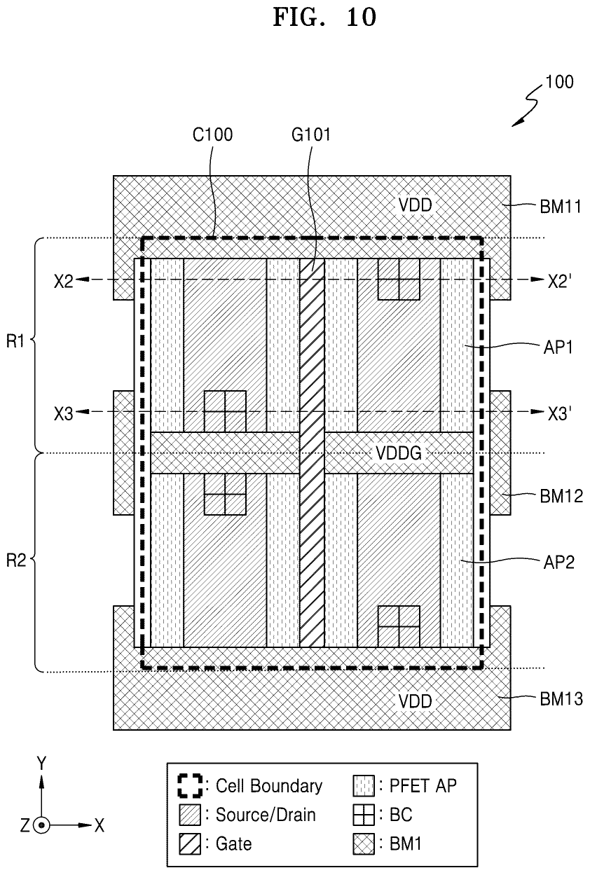

FIG. 10 is a diagram showing a layout 100 of an integrated circuit according to one or more embodiments. For example, FIG. 10 shows the layout 100 including a power gating cell C100 that includes a backside contact as described above with reference to FIG. 1B. As shown in FIG. 10, the layout 100 may include the first backside pattern BM11, the second backside pattern BM12, the third backside pattern BM13, and the power gating cell C100.

The first backside pattern BM11, the second backside pattern BM12, and the third backside pattern BM13 may extend in the X-axis direction. The positive supply voltage VDD may be applied to the first backside pattern BM11 and the third backside pattern BM13, and the source supply voltage VDDG may be applied to the second backside pattern BM12. The power gating cells C100 may be sequentially arranged in the first row R1 and the second row R2. The power gating cell C100 may include a gate G101 extending in the Y-axis direction, and may include a first PFET active pattern AP1 and a second PFET active pattern AP2 extending in the X-axis direction. Accordingly, the power gating cell C100 may include a first PFET formed by the gate G101 and the first PFET active pattern AP1 and a second PFET formed by the gate G101 and the second PFET active pattern AP2. In some embodiments, a power gating cell may include two or more gates and may include more than two transistors.

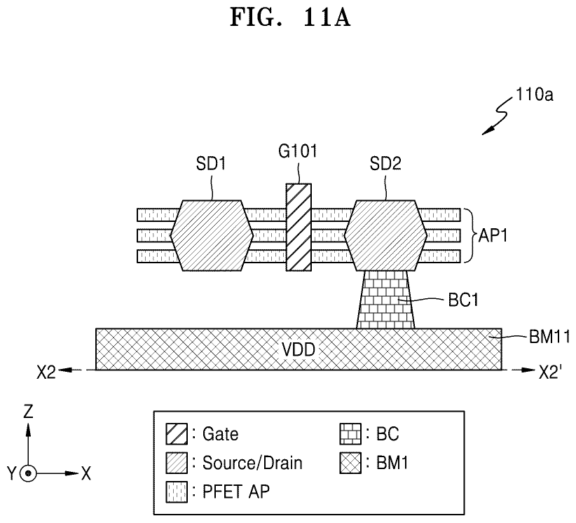

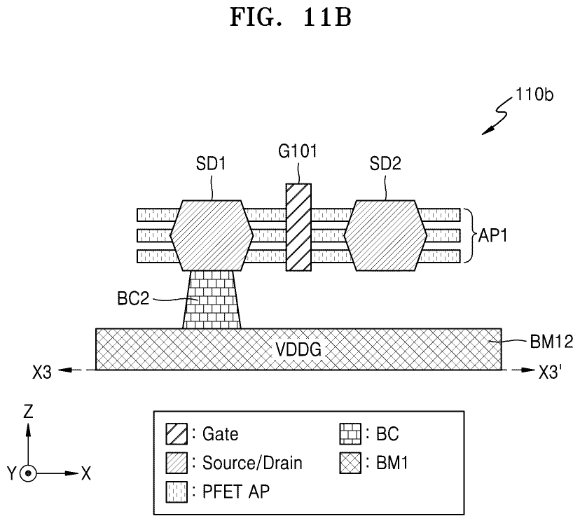

The first PFET may include a drain connected to the first backside pattern BM11 through a backside contact and a source connected to the second backside pattern BM12 through a backside contact. In addition, the second PFET may include a source connected to the second backside pattern BM12 through a backside contact and a drain connected to the third backside pattern BM13 through a backside contact. A cross-section taken along a line X2-X2′ will be described below with reference to FIG. 11A, and a cross-section taken along a line X3-X3′ will be described below with reference to FIG. 11B.

FIGS. 11A and 11B are diagrams showing layouts 110a and 110b of an integrated circuit according to one or more embodiments. For example, FIG. 11A shows a cross-section of the layout 100 of FIG. 10 taken along the line X2-X2′, and FIG. 11B shows a cross-section of the layout 100 of FIG. 10 taken along the line X3-X3′. That is, FIGS. 11A and 11B show the cross-sections of a first PFET included in the power gating cell C100 of FIG. 10 taken at different positions.

Referring to FIG. 11A, the first PFET active pattern AP1 may extend in the X-axis direction and intersect the gate G101. The first source/drain SD1 and the second source/drain SD2 may be placed on both sides of the gate G101. The first backside pattern BM11 may extend in the X-axis direction, and the first backside contact BC1 may extend from a top surface of the first backside pattern BM11 to a bottom surface of the second source/drain SD2. Accordingly, the drain of the first PFET may be connected to the first backside pattern BM11, and the positive supply voltage VDD may be applied to the first backside pattern BM11.

Referring to FIG. 11B, the first PFET active pattern AP1 may extend in the X-axis direction and intersect the gate G101. The first source/drain SD1 and the second source/drain SD2 may be placed on both sides of the gate G101. The second backside contact BC2 may extend from a top surface of the second backside pattern BM12 to a bottom surface of the first source/drain SD1. Accordingly, the source of the first PFET may be connected to the second backside pattern BM12, and the source supply voltage VDDG may be applied to the source of the first PFET.

FIG. 12 is a diagram showing a layout 120 of an integrated circuit according to one or more embodiments. For example, as described above with reference to FIGS. 8A to 8C, FIG. 12 shows the layout 120 including a power gating cell C120 that receives the source supply voltage VDDG from one front-side pattern and provides the positive supply voltage VDD to two front-side patterns. As shown in FIG. 12, the layout 120 may include the first backside pattern BM11, the second backside pattern BM12, the third backside pattern BM13, and the power gating cell C120.

The first backside pattern BM11, the second backside pattern BM12, and the third backside pattern BM13 may extend in the X-axis direction. The positive supply voltage VDD may be applied to first backside pattern BM11 and the third backside pattern BM13, and the source supply voltage VDDG may be applied to the second backside pattern BM12. In addition, the first front-side pattern M11, the second front-side pattern M12, and the third front-side pattern M13 may extend in the X-axis direction. As described above with reference to FIGS. 8A to 8C and FIG. 9, the first front-side pattern M11, the second front-side pattern M12, and the third front-side pattern M13 may be respectively connected to the first backside pattern BM11, the second backside pattern BM12, and the third backside pattern BM13 through through silicon vias.

The power gating cell C120 may be sequentially arranged in the first row R1 and the second row R2. The power gating cell C120 may include a gate G121 extending in the Y-axis direction, and may include the first PFET active pattern AP1 and the second PFET active pattern AP2 extending in the X-axis direction. Accordingly, the power gating cell C120 may include a first PFET formed by the gate G121 and the first PFET active pattern AP1 and a second PFET formed by the gate G121 and the second PFET active pattern AP2. In some embodiments, a power gating cell may include two or more gates and may include more than two transistors.

A source of the first PFET may be connected to the second front-side pattern M12 through a third contact CA3, and accordingly, the source of the first PFET may receive the source supply voltage VDDG through the second front-side pattern M12. In addition, a drain of the first PFET may be connected to the first front-side pattern M11 through the first contact CA1, and accordingly, the first backside pattern BM11 may receive the positive supply voltage VDD through the first front-side pattern M11. A source of the second PFET may be connected to the second front-side pattern M12 through the third contact CA3, and accordingly, the source of the second PFET may receive the source supply voltage VDDG through the second front-side pattern M12. In addition, a drain of the second PFET may be connected to the third front-side pattern M13 through the second contact CA2, and accordingly, the third backside pattern BM13 may receive the positive supply voltage VDD through the third front-side pattern M13.

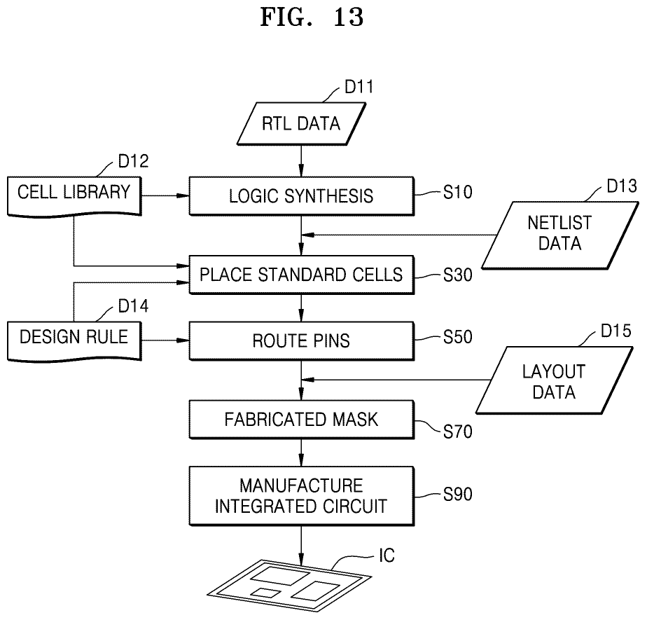

FIG. 13 is a flowchart illustrating a method of manufacturing an integrated circuit IC according to one or more embodiments. Specifically, the flowchart of FIG. 13 shows an example of the method of manufacturing the integrated circuit IC including cells. As shown in FIG. 13, the method of manufacturing the integrated circuit IC may include a plurality of operations S10, S30, S50, S70, and S90.

A cell library (or standard cell library) D12 may include information about cells, such as information about functions, characteristics, layout, etc. In some embodiments, the cell library D12 may define a power gating cell, an end cell, the power tap cell PTC, etc. The power gating cell may provide power gating in a structure in which power is supplied through backside patterns extending from a backside wiring layer, and accordingly, a voltage drop due to power gating may be minimized.

A design rule D14 may include requirements that a layout of the integrated circuit IC needs to comply with. For example, the design rule D14 may include requirements for a distance (space) between patterns in the same layer, the minimum width of a pattern, a routing direction of a wiring layer, etc. In some embodiments, the design rule D14 may define the minimum width of an active pattern, the minimum separation distance between active patterns, etc.

In operation S10, a logic synthesis operation may generate netlist data D13 from register transfer level (RTL) data D11. For example, a semiconductor design tool (e.g., a logic synthesis tool) may generate a bitstream or the netlist data D13 including a netlist, by performing the logic synthesis operation using the cell library D12 and the RTL data D11 prepared using a hardware description language (HDL) such as a very high-speed integrated circuits (VHSIC) hardware description language (VHDL) or Verilog. The netlist data D13 may serve as input for place and routing (P&R), which will be described below. Herein, the netlist data D13 may be referred to as input data.

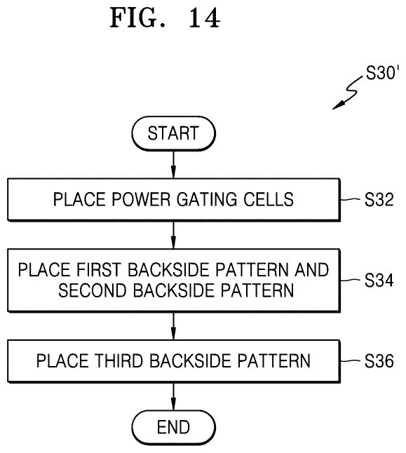

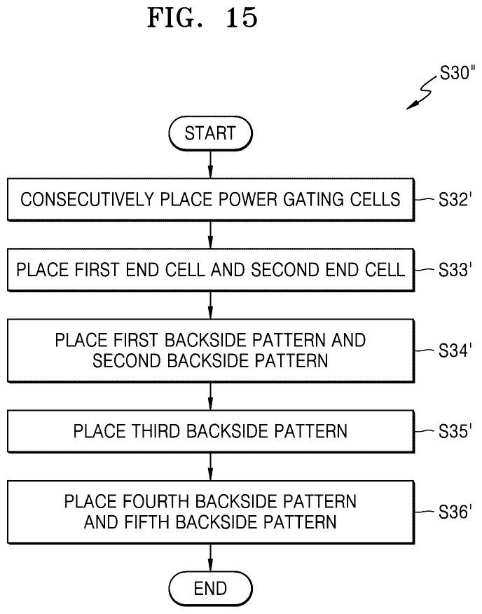

In operation S30, cells may be placed. For example, a semiconductor design tool (e.g., a P&R tool) may place cells used in the netlist data D13 with reference to the cell library D12 and the design rule D14. In some embodiments, the semiconductor design tool may place a power gating cell and place backside patterns in a backside wiring layer. Examples of operation S30 will be described below with reference to FIGS. 14 and 15.

In operation S50, pins of cells may be routed. For example, the semiconductor design tool may generate interconnections that electrically connect output pins and input pins of placed functional cells. In addition, the semiconductor design tool may generate interconnections connected to a node to which a positive supply voltage is applied or to a node to which a negative supply voltage is applied to provide power to functional cells. The interconnection may include a via of a via layer and/or a pattern of a wiring layer. The semiconductor design tool may generate layout data D15 defining the placed cells and the generated interconnections. The layout data D15 may have a format such as graphic design system II (GDSII) and may include geometric information of the cells and the interconnections. The semiconductor design tool may refer to the design rule D14 while routing the pins of the cells. The layout data D15 may correspond to the output of P&R. Operation S50 alone, or operations S30 and S50 collectively, may be referred to as a method of designing the integrated circuit IC.

In operation S70, an operation of fabricating a mask may be performed. For example, optical proximity correction (OPC) to correct distortion such as refraction due to the characteristics of light in photolithography may be applied to the layout data D15. Patterns on the mask may be defined to form patterns arranged on a plurality of layers based on OPC applied data, and at least one mask (or photomask) may be fabricated to form patterns on each of the plurality of layers. In some embodiments, the layout of the integrated circuit IC may be limitedly modified in operation S70, and the limited modification of the integrated circuit IC in operation S70, which is post-processing to optimize a structure of the integrated circuit IC, may be referred to as design polishing.

In operation S90, an operation of manufacturing the integrated circuit IC may be performed. For example, the integrated circuit IC may be manufactured by patterning the plurality of layers by using the at least one mask fabricated in operation S70. Front-end-of-line (FEOL) may include planarizing and cleaning a wafer, forming a trench, forming a well, forming a gate electrode, and forming a source and a drain. By the FEOL, individual devices such as transistors, capacitors, resistors, etc. may be formed on a substrate. In addition, back-end-of-line (BEOL) may include, for example, silicidizing gate, source, and drain regions, adding a dielectric, planarizing, forming a hole, adding a metal layer, forming a via, forming a passivation layer, etc. By the BEOL, individual devices such as transistors, capacitors, resistors, etc. may be interconnected. In some embodiments, middle-of-line (MOL) may be performed between the FEOL and the BEOL and contacts may be formed on the individual devices. The integrated circuit IC may then be packaged in a semiconductor package and used as a component in a variety of applications.

FIG. 14 is a flowchart showing a method of designing an integrated circuit according to one or more embodiments. For example, the flowchart in FIG. 14 shows an example of operation S30 in FIG. 13. As described above with reference to FIG. 13, cells may be placed in operation S30′ of FIG. 14. As shown in FIG. 14, operation S30′ may include a plurality of operations S32, S34, and S36. In some embodiments, the plurality of operations S32, S34, and S36 may be performed in a different order from shown in FIG. 14.

Referring to FIGS. 8A, 8B and 8C together with FIG. 14, power gating cells may be placed in operation S32. For example, a semiconductor design tool may regularly place power gating cells before placing functional cells. As described above with reference to the figures, the power gating cells may provide or block the positive supply voltage VDD based on the source supply voltage VDDG.

In operation S34, a first backside pattern and a second backside pattern may be placed. For example, the semiconductor design tool may place the first backside pattern and the second backside pattern extending in parallel with each other in the X-axis direction in a backside wiring layer. As described above with reference to the drawings, the power gating cells may be multi-height cells consecutively arranged in two rows, and the first backside pattern and the second backside pattern may extend in the X axis direction along boundaries of the power gating cells placed in operation S32. The positive supply voltage VDD provided by the power gating cells may be applied to the first backside pattern and the second backside pattern.

In operation S36, a third backside pattern may be placed. For example, the semiconductor design tool may place the third backside pattern between the first backside pattern and the second backside pattern placed in operation S34 in the backside wiring layer. As described above with reference to the drawings, the third backside pattern may extend in the X-axis direction along a boundary between two rows in which the power gating cells are placed. The source supply voltage VDDG applied to the third backside pattern may be provided to the power gating cells.

FIG. 15 is a flowchart showing a method of designing an integrated circuit according to one or more embodiments. For example, the flowchart in FIG. 15 shows an example of operation S30 in FIG. 13. As described above with reference to FIG. 13, cells may be placed in operation S30″ of FIG. 15. As shown in FIG. 15, operation S30′ may include a plurality of operations S32′, S33′, S34′, S35′, and S36′. In some embodiments, the plurality of operations S32′, S33′, S34′, S35′, and S36′ may be performed in a different order from shown in FIG. 15.

In operation S32′, power gating cells may be consecutively placed. For example, as described above with reference to FIG. 7, a semiconductor design tool may sequentially place the power gating cells in the X-axis direction. The power gating cells may correspond to switches connected in in parallel with each other, thereby reducing the on-resistance of power gating.

In operation S33′, a first end cell and a second end cell may be placed. For example, the cell library D12 of FIG. 13 may define not only power gating cells but also end cells placed adjacent to the power gating cells. In operation S33′, the semiconductor design tool may place the first end cell on one side of the power gating cells consecutively arranged, and may place the second end cell on the other side.

In operation S34′, a first backside pattern and a second backside pattern may be placed. For example, the semiconductor design tool may place the first backside pattern and the second backside pattern extending in parallel with each other in the X-axis direction in a backside wiring layer. As described above with reference to the drawings, the power gating cells may be multi-height cells consecutively arranged in two rows, and the first backside pattern and the second backside pattern may extend in the X axis direction along boundaries of the power gating cells placed in operation S32′. The positive supply voltage VDD provided by the consecutively placed power gating cells may be applied to the first backside pattern and the second backside pattern. As described above with reference to FIG. 7, etc., the first backside pattern and the second backside pattern may extend without ending in the first end cell and the second end cell placed in operation S33′.

In operation S35′, a third backside pattern may be placed. For example, the semiconductor design tool may place the third backside pattern between the first backside pattern and the second backside pattern placed in operation S34′ in the backside wiring layer. As described above with reference to the drawings, the third backside pattern may extend in the X-axis direction along a boundary between two rows in which the power gating cells are placed. The source supply voltage VDDG applied to the third backside pattern may be provided to the power gating cells. As described above with reference to FIG. 7, etc., the third backside pattern may end in the first end cell and the second end cell placed in operation S33′.

In operation S36′, a fourth backside pattern and a fifth backside pattern may be placed. For example, the semiconductor design tool may place the fourth backside pattern and the fifth backside pattern extending in the X-axis direction in the backside wiring layer so that the third backside pattern placed in operation S35′ is between the fourth backside pattern and the fifth backside pattern. The negative supply voltage VSS may be applied to the fourth backside pattern and the fifth backside pattern, and accordingly, in a region where the power gating cells placed in operation S32′ and the first end cell and the second end cell placed in operation S33′ are not placed, backside patterns to which the positive supply voltage VDD is applied and backside patterns to which the negative supply voltage VSS is applied may be alternately placed.

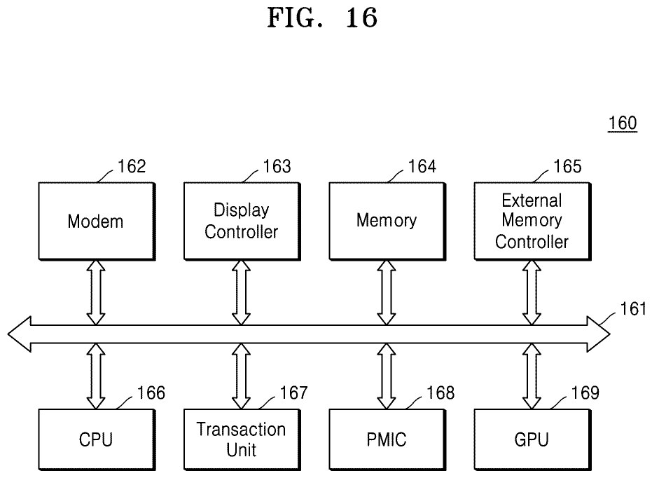

FIG. 16 is a block diagram illustrating a system-on-chip (SoC) 160 according to one or more embodiments. The SoC 160 is a semiconductor device including an integrated circuit according to one or more embodiments. The SoC 160 may be a single chip on which complex function blocks such as intellectual property (IP) blocks configured to perform various functions are provided, and may be designed by using a method of designing the integrated circuit according to one or more embodiments, thereby providing power gating of a high reliability. Referring to FIG. 16, the SoC 160 may include a modem 162, a display controller 163, a memory 164, an external memory controller 165, a Central Processing Unit (CPU) 166, a transaction unit 167, a Power Management Integrated Circuit (PMIC) 168, and a Graphic Processing Unit (GPU) 169, and the function blocks of the SoC 160 may communicate with each other through a system bus 161.

The CPU 166 capable of controlling operations of the SoC 160 at the topmost layer may control operations of the other function blocks 162 to 169. The modem 162 may demodulate signals received from the outside the SoC 160, or may modulate signals generated in the SoC 160 and transmit the signals to the outside of the SoC 160. The external memory controller 165 may control operations of transmitting and receiving data to and from an external memory device connected to the SoC 160. For example, a program and/or data stored in the external memory device may be provided to the CPU 166 or the GPU 169 under control by the external memory controller 165. The GPU 169 may execute program instructions related to graphics processing. The GPU 169 may receive graphic data through the external memory controller 165, and may transmit graphic data processed by the GPU 169 to the outside of the SoC 160 through the external memory controller 165. The transaction unit 167 may monitor data transaction in each of the function blocks, and the PMIC 168 may control power supplied to each of the function blocks under control by the transaction unit 167. The display controller 163 may control a display (or a display device) outside the SoC 160 to transmit data generated in the SoC 160 to the display. The memory 164 may include a nonvolatile memory such as electrically erasable programmable read-only memory (EEPROM), flash memory, etc., and may include a volatile memory such as dynamic random access memory (DRAM), static random access memory (SRAM), etc.

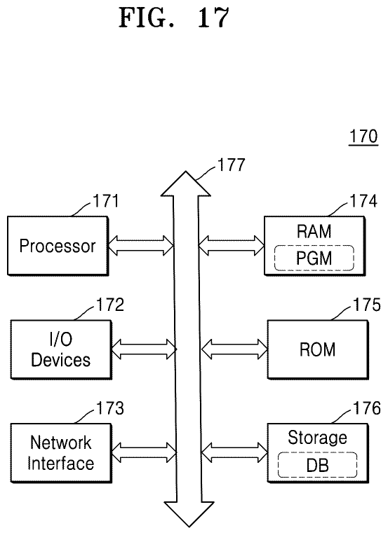

FIG. 17 is a block diagram illustrating a computing system 170 including a memory storing a program according to one or more embodiments. At least some of operations included in a method of designing an integrated circuit, for example, the flowchart described above, according to some embodiments may be performed by the computing system 170 (or a computer).

The computing system 170 may be a fixed computing system such as a desktop computer, a workstation, or a server, or may be a portable computing system such as a laptop computer. As shown in FIG. 17, the computing system 170 may include a processor 171, input/output devices 172, a network interface 173, random access memory (RAM) 174, read only memory (ROM) 175, and a storage 176. The processor 171, the input/output devices 172, the network interface 173, the RAM 174, the ROM 175, and the storage 176 may be connected to a bus 177 and communicate with each other through the bus 177.

The processor 171 may be referred to as a processing unit, and may include at least one core such as a micro-processor, an application processor (AP), a digital signal processor (DSP), or a GPU, which is capable of executing an arbitrary set of instructions (for example, Intel Architecture-32 (IA-32), 64-bit extension IA-32, x86-64, PowerPC, Sparc, MIPS, ARM, IA-64, etc.) For example, the processor 171 may access a memory, that is, the RAM 174 or the ROM 175 through the bus 177, and may execute instructions stored in the RAM 174 or the ROM 175.

The RAM 174 may store a program PGM or at least a part thereof for a method of manufacturing an integrated circuit according to one or more embodiments, and the program PGM may cause the processor 171 to perform at least some of operations included in a method, for example, methods of FIG. 13, of designing the integrated circuit. That is, the program PGM may include a plurality of instructions executable by the processor 171, and the plurality of instructions included in the program PGM may cause the processor 171 to perform, for example, at least some of operations included in the flowcharts described above.

The storage 176 may not lose data stored therein even when the computing system 170 is powered off. For example, the storage 176 may include a nonvolatile memory device or a storage medium such as a magnetic tape, an optical disk, or a magnetic disk. In addition, the storage 176 may be detachable from the computing system 170. The storage 176 may store the program PGM according to one or more embodiments, and the program PGM or at least a part of the program PGM may be loaded into the RAM 174 from the storage 176 before the program PGM is executed by the processor 171. Alternatively, the storage 176 may store a file written in a program language, and the program PGM or at least a part of the program PGM generated from the file by a compiler, etc. may be loaded into the RAM 174. In addition, as shown in FIG. 17, the storage 176 may store a database DB, and the database DB may include information necessary for designing an integrated circuit, for example, information about designed blocks, the cell library D12 and/or the design rule D14 described with reference to FIG. 13.

The storage 176 may store data to be processed by the processor 171 or data processed by the processor 171. That is, the processor 171 may generate data by processing data stored in the storage 176 according to the program PGM, and may store the generated data in the storage 176. For example, the storage 176 may store the RTL data D11, the netlist data D13, and/or the layout data D15 described with reference to FIG. 13.

The input/output devices 172 may include an input device such as a keyboard or a pointing device, and an output device such as a display device or a printer. For example, a user may use the input/output devices 172 to trigger the execution of the program PGM by the processor 171, input the RTL data D11 and/or the netlist data D13 described with reference to FIG. 13, or check the layout data D15 described with reference to FIG. 13.

The network interface 173 may provide access to a network provided outside the computing system 170. For example, the network may include a plurality of computing systems and a plurality of communication links, and the communication links may include wired links, optical links, wireless links, or any other type of links.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. An integrated circuit comprising:
a plurality of devices disposed on a substrate;
a first backside pattern and a second backside pattern extending in a first direction in parallel with each other, the first and the second backside patterns being disposed in a backside wiring layer below the substrate and configured to receive a first supply voltage provided to the plurality of devices; and
a third backside pattern extending in the first direction between the first backside pattern and the second backside pattern in the backside wiring layer and configured to receive a source supply voltage,
wherein at least one of the plurality of devices is configured to provide or block the first supply voltage based on the source supply voltage.

2. The integrated circuit of claim 1, further comprising:
a fourth backside pattern and a fifth backside pattern extending in the first direction between the first backside pattern and the second backside pattern in the backside wiring layer and configured to receive a second supply voltage provided to the plurality of devices,
wherein the third backside pattern is aligned with the fourth backside pattern and the fifth backside pattern in the first direction between the fourth backside pattern and the fifth backside pattern.

3. The integrated circuit of claim 1, further comprising:
a sixth backside pattern and a seventh backside pattern extending in the first direction in parallel with each other, the sixth and the seventh backside patterns being disposed in the backside wiring layer and configured to receive a second supply voltage provided to the plurality of devices,
wherein the first backside pattern and the second backside pattern are adjacent to the sixth backside pattern and the seventh backside pattern, respectively, and are disposed between the sixth backside pattern and the seventh backside pattern.

4. The integrated circuit of claim 1, further comprising:
a first front-side pattern and a second front-side pattern extending in the first direction along the first backside pattern and the second backside pattern, respectively, in a front-side wiring layer on the substrate and configured to receive the first supply voltage;
a first through silicon via extending between the first backside pattern and the first front-side pattern; and
a second through silicon via extending between the second backside pattern and the second front-side pattern.

5. The integrated circuit of claim 4, further comprising:
a third front-side pattern extending in the first direction along the third backside pattern in the front-side wiring layer and configured to receive the source supply voltage; and
a third through silicon via extending between the third backside pattern and the third front-side pattern.

6. The integrated circuit of claim 1, wherein
the at least one of the plurality of devices comprises a first transistor comprising a gate configured to receive a power down signal,
the integrated circuit further comprising:
a first backside contact extending between the first backside pattern and a drain of the first transistor; and
a second backside contact extending between the third backside pattern and a source of the first transistor.

7. The integrated circuit of claim 6, wherein
the at least one of the plurality of devices comprises a second transistor comprising a gate configured to receive the power down signal,
the integrated circuit further comprising: a third backside contact extending between the second backside pattern and a drain of the second transistor.

8. An integrated circuit comprising a plurality of cells, the integrated circuit comprising:
at least one power gating cell configured to provide or block a first supply voltage, based on a source supply voltage, provided to the plurality of cells;
a first backside pattern and a second backside pattern extending in a first direction in parallel with each other, the first and the second backside patterns being disposed in a backside wiring layer below a substrate and configured to receive the first supply voltage; and
a third backside pattern extending in the first direction between the first backside pattern and the second backside pattern in the backside wiring layer and configured to receive the source supply voltage.

9. The integrated circuit of claim 8, wherein
the plurality of cells are aligned in a plurality of rows extending in the first direction,
the first backside pattern extends in the first direction along a boundary of a first row,
the second backside pattern extends in the first direction along a boundary of a second row, and
the third backside pattern extends in the first direction along a boundary between the first row and the second row.

10. The integrated circuit of claim 9, wherein
the at least one power gating cell comprises two power gating cells that are consecutively placed in the first row and the second row.

11. The integrated circuit of claim 8, wherein
the integrated circuit further comprises:
a first end cell and a second end cell that are consecutively placed in the first direction, and are placed adjacent to the at least one power gating cell in the first direction, and
the third backside pattern ends below each of the first end cell and the second end cell.

12. The integrated circuit of claim 11, further comprising:
a fourth backside pattern and a fifth backside pattern extending in the first direction between the first backside pattern and the second backside pattern, in the backside wiring layer and configured to receive a second supply voltage provided to the plurality of cells,
wherein the fourth backside pattern ends below the first end cell, and
the fifth backside pattern ends below the second end cell.

13. The integrated circuit of claim 8, further comprising: a sixth backside pattern and a seventh backside pattern extending in the first direction in parallel with each other, the sixth and the seventh backside patterns being disposed in the backside wiring layer and configured to receive a second supply voltage provided to the plurality of cells,
wherein the first backside pattern and the second backside pattern are adjacent to the sixth backside pattern and the seventh backside pattern, respectively, between the sixth backside pattern and the seventh backside pattern.

14. The integrated circuit of claim 8, further comprising:
a first front-side pattern and a second front-side pattern extending in the first direction along the first backside pattern and the second backside pattern, respectively, in a front-side wiring layer on the substrate and configured to receive the first supply voltage;
a first power tap cell comprising a through silicon via extending between the first backside pattern and the first front-side pattern; and
a second power tap cell comprising a through silicon via extending between the second backside pattern and the second front-side pattern.

15. The integrated circuit of claim 14, further comprising:
a third front-side pattern extending in the first direction along the third backside pattern in the front-side wiring layer and configured to receive the source supply voltage; and
a third power tap cell comprising a through silicon via extending between the third backside pattern and the third front-side pattern.

16. The integrated circuit of claim 8, wherein the at least one power gating cell comprises:
a first transistor comprising a gate configured to receive a power down signal;
a first backside contact extending between the first backside pattern and a drain of the first transistor; and
a second backside contact extending between the third backside pattern and a source of the first transistor.

17. The integrated circuit of claim 16, wherein the at least one power gating cell further comprises:
a second transistor comprising a gate configured to receive the power down signal;
a third backside contact extending between the second backside pattern and a drain of the second transistor.

18. A method of manufacturing an integrated circuit comprising a plurality of cells, the method comprising:
placing at least one power gating cell configured to provide or block a first supply voltage, based on a source supply voltage, provided to the plurality of cells;
placing a first backside pattern and a second backside pattern extending in a first direction in parallel with each other, the first and the second backside pattern being disposed in a backside wiring layer below a substrate and configured to receive the first supply voltage; and
placing a third backside pattern extending in the first direction between the first backside pattern and the second backside pattern in the backside wiring layer and configured to receive the source supply voltage.

19. The method of claim 18, wherein
the at least one power gating cell comprises two power gating cells,
the placing the at least one power gating cell comprises consecutively placing the two power gating cells in the first direction,
the method further comprises placing a first end cell and a second end cell to be adjacent to the at least one power gating cell in the first direction, and
the third backside pattern ends below each of the first end cell and the second end cell.

20. (canceled)

21. The method of claim 18, further comprising:
generating layout data defining a layout of the integrated circuit;
fabricating a mask, based on the layout data; and
manufacturing the integrated circuit, based on the mask.

22. (canceled)
